(19) United States
(12) Patent Application Publication
(10) Pub. No.: US 2009/0112706 A1
(43) Pub. Date: Apr. 30, 2009

(54) BUSINESS METHOD FOR COMPOUND ATTRIBUTES CREATION AND MARKETING

(75) Inventors: Marina Gazetova, Visaginas (LT); Liudmila Gazetova, Visaginas (LT); Rafael Gazetov, Visaginas (LT)

Correspondence Address: YOUNG & THOMPSON, 209 Madison Street, Suite 500, ALEXANDRIA, VA, 22314, US

(73) Assignee: UAB "IEEC", VILNIUS (LT)

(21) Appl. No.: 11/877,704

(22) Filed: Oct. 24, 2007

(51) Int. Cl. G06Q 30/00

(52) U.S. Cl. 705/14

(57) ABSTRACT

A method for compound attributes creation and marketing uses multiple sales or free of charge assignation of definite rights for person's or legal entity's attributes. Compound attributes contain permanent and variable parts, which are united by single visual, virtual or sound solution as a recognizable symbol of definite design. The permanent part contains a person's or legal entity's attributes of sellers and is arranged in one part of the recognizable symbol. The variable part contains the person's or legal entity's attributes of purchasers and is arranged in another part of the recognizable symbol. Compound person's or legal entity's attributes owners form a social seller's network on a profit sharing bases between them as shareholders within the seller's network, for example in terms of stock company, public company or organizations which provides mass selling and marketing of products, services or advertisement.

### FIELD OF THE INVENTION

The present invention relates to the Internet based business methods of person's or legal entity's compound attributes creation and marketing. The present invention reveals trends relevant to new brand opportunities for persons or legal entities, for example from celebrities to their fans or worshippers, from brand or branch owners to their consumers, worshippers, users or other clients. The present invention can be broadly applied in different fields and spheres of human activities, in all community groups, for example business, science, sport, art, culture, music and other spheres, in all community groups, where multiple sales of definite rights for person's or legal entity's attributes use from sellers to purchasers and creation of independent compound person's or legal entity's attributes between sellers and purchasers can take place from persons to persons, from legal entities to persons, from persons to legal entities, from legal entities to legal entities.

### BACKGROUND OF THE INVENTION

In the traditional brand selling, where sellers are owners of person's attributes, legal entity's attributes or classical brands, they sell them to purchasers for a fixed price and under the definite rights, and as a result of such bargain, the owners of person's or entity's attributes become purchasers and sellers lose ownership on person's or legal entity's attributes.

Thus, traditional brand selling does not use competitive advantages and new opportunities which are introduced by independent compound person's or legal entity's attributes, for example independent compound brands, pictures, intellectual properties, properties, rights, place, space, money, currency, spaces of time, duration of time, phone numbers, mobile phone numbers, words, phrases, songs, sound, languages, energy, light, water, foods, smells, taste, air or gas quotes of emission and other compound attributes, and it does not use strong motivation of independent compound person's or legal entity's attribute owners, which strengthens their ability to sell.

### SUMMARY OF THE INVENTION

The present invention has been made to overcome the disadvantages as mentioned above, and therefore, aims to introduce the business method of person's or legal entity's compound attributes creation and marketing, that allows any persons or legal entities, for example leaders, celebrities or other famous persons and their worshippers, fans, brand owners and their clients, companies and their customers, consumers to create new joint products and effective tools in the form of independent compound person's or legal entity's attributes, for example independent compound brands, pictures, intellectual properties, money, currency, spaces of time, duration of time, phone numbers, mobile phone numbers, words, phrases, songs, sound, energy, light, water, foods, smells, taste, air or gas quotes of emission and other person's or legal entity's compound attributes. The present invention gives new opportunities for different groups within the community, in public and business sector, including direct sales sector and other fields and spheres.

In the present invention, the business method of person's or legal entity's compound attributes creation and marketing is performed by multiple sales or free of charge assignation of definite rights for the use of person's or legal entity's attributes from sellers to purchasers, namely: from persons to persons; from legal entities to persons; from persons to legal entities, from legal entities to legal entities with simultaneous creation of compound person's or legal entity's attributes, for example independent compound brands, pictures, intellectual properties, properties, rights, place, space, money, currency, spaces of time, duration of time, phone numbers, mobile phone numbers, words, phrases, songs, sound, energy, light, water, foods, smells, taste, air or gas quotes of emission and other compound attributes between them, and purchasers become owners of compound person's or legal entity's attributes. In other cases, sellers could become owners of compound person's or legal entity's attribute as well. Then a definite fee is paid by purchasers to sellers for the right to use person's or legal entity's attributes.

In the present invention, compound person's or legal entity's attributes contain permanent and variable parts, which are united by single visual, virtual or sound solution as recognisable symbol of definite design, for example definite shapes, dimensions, colours, colour background, sound, sound background, spaces of time, durations of time, for example in term of existing design of brands, denominations, currency, money, banknotes, coins, bank credit cards, capital issues or other existing designs with zero, negative or positive measurement units by way of mathematic, physical or other expressions or formula or any other design.

In the present invention, permanent part contains person's or legal entity's attributes of sellers, for example names, surnames, popularity, reputation, trust, prestige, identification numbers, images, pictures, brands, trade marks, logotypes, intellectual properties, properties, rights, place, space, money, currency, phone numbers, mobile phone numbers, spaces of time, words, phrases, songs, sound, languages, energy, light, water, foods, smells, taste, air or gas quotes of emission and other person's or legal entity's attributes of sellers and is arranged in one, e.g., the right or top part of symbol.

In the present invention, variable part contains person's or legal entity's attributes of purchasers, for example names, surnames, popularity, reputation, trust, prestige, identification numbers, images, pictures, individual corporate parent brands, trade marks, logotypes, intellectual properties, properties, rights, place, space, money, currency, phone numbers, mobile phone numbers, spaces of time, words, phrases, songs, sound, languages, energy, light, water, smells, taste, air or gas quotes of emission and other person's attributes or legal entity's attributes of purchasers and is arranged in the other e.g., the left or bottom part of symbol.

In the present invention, compound person's or legal entity's attribute owners form seller's network as shareholders within seller's network, for example in terms of stock company, public company or other organizations on a profit sharing bases between them, wherein amount of shares proportionate to the cost of definite rights for seller's attributes uses, providing mass sales and marketing of products, services or advertisement.

In the present invention, from the one site, there are many successful leaders, celebrities and other famous persons who have reached definite popularity in the different layers of the society in the world and who have high level of credibility from the side of their worshippers or fans. To these celebrities belong many famous sportsmen, musicians, actors, politicians, scientists, businessmen. The level of their popularity, reputation, credibility in the society starts to grow in the definite time then reaches own maximum and then falling off i.e. it is characterized by definite period of life-time. Many leaders are managing their popularity and reputation quite successfully and can convert it to the definite benefits and profits. However, everyone thinks how to raise the level of their popularity, reputation and credibility, and to increase the life-time of their popularity and ensure long-life time of reached high level of popularity and long-time their conversion to the benefits and profits. However many of leaders do not have abilities of commercialist and can not to dispose of their popularity correctly. But they also want to be more financial successful and convert their popularity to the required benefits and profits. Nevertheless, not all can do it in reality.

From the other side, such popular and successful leaders in the society has multi million audience of worshippers and fans. Majority of worshippers want to be near their leaders very much and wants to be associated with them, feel their possession to the famous people and to be joined with them by some mutually probable background. It lets them to increase the level of own popularity in the society and then convert it to the required benefits and profits in the future.

Popularity, reputation and trust have immense power and are a very effective instrument which plays decisive role in the society. Fans, worshippers, customers or consumers pay significant attention to the popularity and reputation of their leaders, celebrities, or brand owners, with whom they want to cooperate, and actively share their opinion within the society. Taking into consideration the great speed at which opinions and impressions are shared, leaders, celebrities, or brand owners as network's owners understand, that long-lasting success is based on a combination of their own popularity and reputation, and good knowledge of needs and wants of their worshippers, fans, customers or consumers. Multi-million audience of independent compound attribute owners that form social network, creates necessary and significant sets of criteria and characteristics which are used for their own and their leaders' appraisal. Thus, popularity, trust and solid reputation play the key role in the life of worshippers and fans and are the most valuable assets that leaders possess.

The business method of compound attributes creation and marketing allows to implement multiple exchange of popularity between leaders and their worshippers, which is accompanied by creation of variety independent compound attributes between leader and worshippers. Independent compound attribute owners form leader's network, for example in terms of stock companies. As a result of such multiple exchange, the level of popularity, trust and reputation of leaders in the society is grown up essentially and popularity of their lifetime is expanding, what lets them to implement, longtime conversion of own popularity, trust and reputation to the benefits and profits.

The creation of independent compound attributes is based on mutual desire, in particular from the one side—desire of famous people and leaders to expand own publicity and level of popularity, trust, reputation, life-time of their popularity, to create own networks from the thousands and billions of worshipers and to get own benefits and profits, and from the other side—desire of their worshipers to own and expand own popularity by joining leaders popularity and obtaining new opportunities and get own benefits and profits.

Besides visual compound attributes, leaders and worshippers can create sound compound attributes between each other. For example, famous singer Robby Williams can create with own worshippers many sound compound attributes, which could be added by music compositions of Robby Williams together with each of billion of own worshippers. Independent compound sound attributes can contain mutually performed music composition or songs in full or partly.

As a society of independent compound attribute owners is transforming to the leader's network, in the process of increasing popularity, trust and reputation, all will be proceed with higher speed, without sensible efforts as from the side of leaders as appraising them worshippers. Leader's network is a very flexible virtual “network reputation and popularity market” of leaders and their worshippers, where great atmosphere of trust to each other is formed. Actually, leader's networks is a second type of “authority” mass media, which is exists on account of billion of independent compound attribute owners, which can be characterized as “information mediator” on the “network reputation and popularity market”.

The main component and instrument in this universal method of leaders and their worshipers alliance is independent compound person's or legal entity's attributes, as universal method of leaders self-expression though their worshippers, as worshippers though their leaders, which gives to each side new opportunities, goals, and paths to its achievements.

Independent compound person's or legal entity's attributes is a common denominator, which lets to worshippers to be closer to own leaders, and to leaders come down from the heaven and be closer to their worshippers without damage of own image, brands and other person's or legal entity's attributes.

Independent compound person's or legal entity's attributes let to archive own goals to leaders and their worshippers without any contradictions independent compound attributes work for idols and theirs worshipers in the different surfaces and directions. In principal, in this unique global business method—each worshiper has a feeling of belonging to real elite, which is not accessible to everyone through independent compound attributes.

Independent compound attributes are the centre of gravity between leaders and worshippers, which define the quality of communal dialog and detect definite relationship culture between leaders and worshippers. Thus, leaders intrude to the created societies—Independent compound attributes owner networks and, as a part of this society, make communal movements to the raised goals. Such networks obtain longtime and stable links based on mutual trust and understanding. Integral and limited strategy of independent compound attributes will let leaders and worshippers make corrections according to the changes permanently in the consumable society.

Business method for compound attributes creation and marketing gives an opportunity to each leader to convert multibillion auditory of own worshippers to purchasers and to get following benefits and profits:

Growth of the level of popularity, reputation and trust in the society; support of the popularity, reputation and trust on the maximal high level as long as possible—expanding life time.

Each leader has an opportunity of own branched network, consisted of billion loyal worshippers—life brands, to advertise and promote, and also has an availability of any products or services distribution though such network.

Thus, such leader becomes and object for investment and obtains availability to convert own popularity, reputation, trust and prestige to the creation and widening of own business and to get real benefits and profits.

Business method for compound attributes creation and marketing gives an opportunity to each worshipper to get following benefits and profits:

The level of popularity of each worshiper is obtaining or growing up in the society.

Each worshipper as independent compound attributes owner, becomes a competent member of branched network, the head of which is their leader.

Thereby, each worshipper obtains a possibility to invest into his own leaders, their popularity, reputation and trust, which are their intangible assets, getting opportunity to create own business or continue developing existing business in the structure of his leaders' branched networks

Business method for compound attributes creation and marketing helps to find common language between leaders and worshippers. For millions of worshippers, independent compound attributes are thereby valuable character which has their leader. Worshippers would like to have such character, and are ready to pay own money. Thereat, independent compound attributes will exist and be alive till worshippers are ready to believe in own leaders.

Hereby, independent compound attributes arise in the communication process and are a complex construction uniting leaders with their worshipers which together fill independent compound attributes with definite meaning and value due to common and mutually profitable relationships. Stable and strong independent compound attributes will be obliged for its longevity to long-term and bilateral relations.

Stability of independent compound attributes is the most important factor. To have long-term and stable relationships, leaders have to learn to accept their worshippers as alive people, and their networks—as friendly to them society, to which they can trust their popularity, reputation, prestige, their name, brands and other attributes of leaders. To achieve great success, leaders have to know their worshippers.

Independent compound attributes allow leaders to listen to the own worshippers opinion, as clients and consumers and to attract them to the full and joint participation in the development of required products and services and also its realization in the market. During such operation of “compound production” individualization of products according to clients requirements is taken place (customization), what is the guaranty of success and an inherent part of present-day business.

The attraction of worshippers to the “compound production” is based on inspiration, which is springing from the worshippers real life as potential clients, who are able to affect the basic tendency formation. In this case, culture, and needs, worth, and care of potential clients are becoming the factors, which define the direction of “compound production”. If leaders are taking into account the needs of own worshippers, letting them to take part in the process, then these potential clients reciprocate to the leaders and transform to the loyal and real clients and bring the long-time profits to own leaders.

Independent compound attributes bring the idols and their multimillion auditory of worshippers to the new level of compound work, based on mutual dialog in the role of partners, who are participating in the new products developing. Independent compound attribute owners are prosumers who are combining consumer's and producer's roles simultaneously. Factually, in the process of creation of independent compound attributes, worshippers', as potential clients, needs are defined, what replaces long-term market relationship investigation in classical branding.

The time of classical brands passes away. The process of globalization leads to classical brands opposition development. In this globalization process worshippers, as potential clients and consumers of their leaders' products, can move ahead without significant disagreements by using dialogue and co-operation between leaders and worshippers and establishing strong and long-lasting partnership. The business method for compound attributes creation and marketing gives opportunity for eliminating significant disagreements and creating mutual integration. In this context, independent compound attributes are a form of mutual communication which provides leaders with opportunity to create their own inner network culture that would help them to receive and sensitively react on every vibration within changeable business environment and would protect them from possible commotion.

Independent compound attributes allows leaders to treat their worshippers as “living” brands and as a goal, and not means, of the process of production. Confidential relationship between leaders and their worshippers, as potential customers, is established at an early stage even before creating independent compound attributes. Opinions, needs and wants of independent compound attribute owners are the driving force for reaching the set goals. Independent compound attribute owners provide full mutual co-operation which would kept in a friendly and creative environment. Independent compound attributes can enter any market within the shortest periods of time and with minimal use of resources, facilities and efforts. For example, in order to enter the “children's” market it is necessary to attract the children's audience of the certain age group to creating independent compound attributes. Children are very responsive to the credit that their leaders put in them.

Independent compound attribute owners can feel dispositions in the society and move tendencies into required directions, taking into account the taste and preferences of consumers, and it allows creation of a joint product which would be of assured demand. Independent compound attribute owners, as living advertisements, participate in the development and production of the joint product and get response in consumers' imagination, thus inspiring, provoking and stimulating them. Independent compound attribute owners help consumers to interpret the world around them and to look at familiar things from a different angle, thus ensuring their success.

Future belongs to such independent compound attributes, as far as their creation is based on honesty, openness and pathetic attitude to cultural virtues which true leaders possess. Thus, independent compound attributes are extremely effective means of communication between leaders and their worshippers as their potential customers. Independent compound attributes are the change that independent compound attribute owners hope to see in the world around them. In case of massive distribution of independent compound attributes within the passive consumer society, passive consumers will start to take an active part in development and production of the products that they need themselves, with each step getting closer to developing their ideal products. Independent compound attributes are a new kind of freedom which is peculiar to contemporary consumers and allows them to develop and consume the products they need.

Independent compound attributes combine creativity and respectful attitude towards the norms in the society, help to widen the market and give everyone who is willing an opportunity to put their wildest dreams into practice. Independent compound attribute owners, as active living brands, will select the most interesting product themselves, will enrich it with their ideas and will forward it further, ignoring classical brands with spoilt reputation.

The closer the contact between consumers, independent compound attribute owners, and their leaders is, the longer period consumers stay faithful to the leaders. The business method for compound attributes creation and marketing through established business networks helps independent compound attribute owners to build certain relationship and communication with each other, so that they could overcome the difficulties of working in a disjunct and changeable environment and to create fully democratic atmosphere by open interaction and exchange of information between each other. This will give consumers confidence and consistency instead of short-term financial success.

The group of leaders and their independent compound attribute owners form a special community which attracts more and more new worshippers, as consumers, and which gives everyone an opportunity to take an active part in creation of new joint products. Independent compound attribute owner networks are a modern version of meritocracy, a system that determines the position of each independent compound attribute owner according to his abilities. In such networks, the emphasis is put on leading the independent compound attribute owners in the right direction, and not on controlling them. Each independent compound attribute owner would act within the common conception framework and at the same time on an individual basis, being a living advertisement and an independent living brand. The consumers' community treats independent compound attribute owners as massive living advertisement and a living flow of accurate information and knowledge of products, brands, leaders, themselves and the market in whole. Thus, using opportunities provided by independent compound attributes, leaders and worshippers get an instrument for planning, which means acceptance of the unknown and sensibility to new ideas, and an instrument for conversion of popularity, reputation, trust, prestige and other attributes into business opportunities.

Independent compound attributes help leaders to find meaning in every piece of information that comes from independent compound attribute owners. Moreover, leaders get opportunity for receiving condensed and specific information about the market and its demands, as well as for determining factors that allow the community of independent compound attribute owners to identify the centre of their market's gravity in order to distribute resources in the right way and keep the balance. Understanding of these factors will help every leader to promote their innovations on the market more effectively without wasting time, efforts and resources on moving in wrong directions and finding the right way. Only the independent compound attribute owners themselves, as consumers, are able to interpret reasons for changes in the market in the right way. In this case the business method for compound attributes creation and marketing is a new way of communication based on social and emotional interaction between leaders and independent compound attribute owners and on the strength of their motivation, combined into a single and strong consumers' network which allows to understand and react on all market changes.

The business method for compound attributes creation and marketing creates its own branding. Due to its flexibility and uniqueness, it has a big influence on natural evolutionary development in the field of classical branding, and it changes the understanding of branding completely, being the cause and not the result of rapid changes.

Independent compound attributes give opportunity for dialogue between leaders and worshippers, between present and prospective consumers, taking into consideration all their individual characteristics. Independent compound attributes are the kind of product and instrument that helps leaders to go deep into the context of their worshippers' everyday life and to derive inspiration from their consciousness that results in valuable innovations. Dialogue between leaders and worshippers, as well as intra-network dialogue between independent compound attribute owners themselves, is conducted with the help of independent compound attributes. As a result, a certain informational image is formed within the business network, which is shared between independent compound attribute owners and combines all independent compound attribute owners into strong united networks. Business networks consisting of independent compound attribute owners are able to form public opinion and lead it in the desired direction. Such networks can be a source of new ideas that lead to promising decisions.

Every independent compound attributes owner is an individual story based on true facts of his/her life, which is usually shared by people during communication. The alliance of famous classical brand leaders and their worshippers is a well told story about the leader himself and his relationship with his worshippers that conveys their dreams, hopes and virtues which stay alive in worshippers' minds enriching their imagination. Every such story conveys even the most complicated information in a suitable and understandable format, and it is an integral part of communication between leaders and worshippers that is transformed into legends and myths. Every successful story, told by independent compound attributes owners, is a story of their achievements and victories. Simple, consistent and laconic stories, told by independent compound attribute owners about themselves and their leaders, are transferred to other worshippers by using independent compound attributes, thus helping them to shape their thoughts and feelings which become tangible for them and inspiring them to create and tell new successful stories which would encourage more and more worshippers to join the group of independent compound attribute owners. Good stories told by independent compound attribute owners embrace different aspects of their leaders' strategies, so that worshippers would want to act and win, finding meaning in absolutely everything that happens in the context of their own lives and finding their own solutions for the set tasks.

Any stories, told by leaders to their worshippers many times, inspire worshippers and take them to a virtual journey to find the basic meaning or context put by leaders into the stories, thus creating a virtual world of told stories. Stories which are told many times reach the worshippers that become independent compound attribute owners and make another journey from the virtual world back to the real world of network communities and strengthen the communities. Such connection between stories make all independent compound attribute owners participants of the described events, helping them to experience these events and make them their experience in the real world. Expressive power and meaning of simple, meaningful and successful stories told by independent compound attribute owners is a useful tool for creation of products and services which are able to raise noble feelings and motivation and encourage worshippers as potential associates and consumers to act. Visual and sound independent compound attributes, introduced in the form of successful stories, are a good way of successful leaders' presentation and conveying the meaning of successful stories to worshippers as potential consumers, as far as they require less mental energy than mere facts do. Such informal and friendly atmosphere allows leaders and worshippers to reach the maximum productivity in the most creative way and to effectively use all information received on the market. Successful stories which are told many times help to create special atmosphere in which opinions of all worshippers, as prospective consumers and customers, are considered and gladly accepted. The total synergetic effect of individual stories brings to creation of an inner story in every business network consisting of independent compound attribute owners, and it encourages all owners to be even more active.

In business networks, building of long-term relationships between leaders and worshippers, loyalty and faithfulness of independent compound attribute owners to their leaders, as well as total power of group thinking of independent compound attribute owners, are critical factors for positive outcome in market competition. Those leaders, that are the first to understand the necessity and importance of their worshippers' trust, can expect trust and honesty from their worshippers and will have great advantage over those who have not understood it yet. Such advanced leaders realize that in order to make their worshippers be frank and open they need to get closer to them and behave themselves in a simple way, so that worshippers could express their own thoughts and ideas. In order to reach success, leaders should use opportunity for creation of their own business networks consisting of independent compound attribute owners, making them shareholders in the network which will be reorganized into a joint-stock company. New opportunities for leaders start from respectful attitude towards their worshippers and desire to know their lives.

The business method for compound attributes creation and marketing is a bridge between compound brands and classical branding. Thus, classical branding, represented by leaders' brands, is protected from dangers and negative tendencies on the market by independent compound attributes as intermediate barriers and a shield consisting of independent compound attribute owners. Combination and solid tandems of classical leaders' brands and multimillion audience of independent compound attribute owners will allow to create stable business networks in the form of consumers' communities. Every community will develop in its own way, taking into account specifics of their leaders, popularity, reputation, classical brands and other attributes. Leaders and worshippers, which strive to develop joint business, treat independent compound attributes as a set of new knowledge about consumers market and different kinds of relationship within it. Leaders' and worshippers' faith in this knowledge and opportunity of having great relationship replace the anticipated success. Independent compound attributes are a successful formula for market relationship based on true understanding of peculiarities of strange business culture.

Leaders can listen to their worshippers by using the established networks consisting of independent compound attribute owners and react on their needs and wants on time. Focused interactive listening to the independent compound attribute owners is performed on a virtual market, where leaders and worshippers can do joint experiments in order to create new products. Leaders can go beyond passive listening, using the established business networks as “hearing device” and mass media. The main goal of interactive listening is to reach synchronization between leaders and their worshippers in the process of long-term dialogue. Interactive listening is an ongoing process which has no beginning and no end. The key task for the leaders is to learn how to listen and hear their worshippers, and in order to do that they need to be united with their community into a single entity and to establish strong communication with them. Independent compound attributes are mutually profitable investments that leaders and their worshippers put in each other.

The great alliance of classical branding and compound branding allows to influence the market simultaneously. Classical and traditional leaders' brands try to imprint leaders' names in the minds of their worshippers, and compound branding, on the contrary, makes leaders listen to opinions and recommendations that independent compound attribute owners express as customers. Huge potential of the alliance of classical branding and compound branding is based on deep understanding by independent compound attribute owners of the core of things which are rooted in great strikening and inspiration that appear in the process of confidential network cooperation between leaders and worshippers. Compound branding opens a new era of mutually profitable relationships between leaders and independent compound attribute owners, helping them to improve the quality of their lives.

The greater popularity and reputation leaders have and the more successful they are, the bigger social networks they cultivate and the more active part their independent compound attribute owners take in mastering network thinking and methods of work, harmoniously combining the roles of demanding managers and freedom-loving designers. Social reputation networks, consisting of multimillion audience of independent compound attribute owners, are a synthesis of real and virtual, rational and intuitional, that increases the level of emotional knowledge and intuition directed on meeting the needs and demands of the market. Herewith, independent compound attribute owners combine individual intuition with collective thinking and demonstrate strong ability to adapt themselves to a rapidly changing and unpredictable environment and to understand and digest large loads of information.

Independent compound attributes are not the goal, they are an interactive process of multiple sale of popularity, reputation, prestige, trust and other attributes, from leaders to their worshippers. Independent compound attribute owners in the majority do not believe in classical leaders' brands, but in leaders' ideas and the strength of their reputation. Leaders have an opportunity to offer their independent compound attribute owners a certain way and style of life through established networks.

For the new generation (young people of 11-21) independent compound attributes give opportunity to develop and perceive their own self-sufficiency and value, consistence and strong feeling of individuality, to feel themselves being the key group which determines market tendencies. With the help of independent compound attributes, worshippers from the new generation can stay true to themselves, their beliefs and principles, and to adhere to certain social limits at the same time. They will be ready to overmaster bottomless sources of information and will get unlimited opportunities.

### BRIEF DESCRIPTION OF THE DRAWINGS

FIG. 1 is a comprehensive block diagram showing multiple sales or free of charge assignation and marketing process of definite rights for person's or legal entity's attributes uses from seller to million audience of purchasers with creation of independent compound person's or legal entity's attributes and forming seller's network.

FIG. 2 is a comprehensive block diagram showing multiple sales or free of charge assignation and marketing process of definite rights for person's or legal entity's attributes usage from seller to purchasers with creation of independent compound person's or legal entity's attributes and forming seller's network on a profit sharing bases between independent compound person's or legal entity's attribute owners, as shareholders within seller's network, in terms of stock company, public company or other organization, wherein amount of shares proportionate to the cost (price) of definite rights for seller's attributes usage.

FIG. 3 is a comprehensive scheme showing process of taking out a booking by celebrities or brand owners from mobile phone operators and multiple sales or free of charge assignation of definite rights for mobile phone numbers uses from sellers (celebrities, leaders or brand owners), to purchasers, fans, worshippers, customers, users or other clients with creation of compound mobile phone numbers and forming seller's network on a profit sharing bases between independent compound mobile phone number owners, in terms of stock company, public company or other business or public organization.

FIG. 4 is a comprehensive scheme of multiple sales or free of charge assignation of definite rights for mobile phone numbers use from seller to million audience of purchasers with creation of independent compound mobile phone numbers and forming seller's network on a profit sharing bases between independent compound person's or legal entity's attribute owners, as shareholders, within seller's network, in terms of stock company, public company or other business or public organizations.

FIG. 5 is scheme showing example of single design of independent compound attributes in terms of independent compound brand between BMW, as famous brand, and his purchasers, (customers, fans, worshippers, users and other clients), for example Rafael Gazetov, Liudmila Gazetova, Marina Gazetova, as purchasers and compound brand owners and forming BMW's network.

FIG. 6A is scheme showing example of single design of independent compound person's attributes, independent compound legal entity's attributes, independent compound brands or independent compound currency, banknotes or other money between Arnold Schwarzenegger, as celebrity, and Rafael Gazetov, as worshipper, in terms of existing 100 dollar's banknote with arrangement of personal attributes of Rafael Gazetov, as purchaser, on the right.

FIG. 6B is scheme showing example of single design of independent compound person's attributes, independent compound legal entity's attributes, independent compound brands or independent compound currency (money) between Arnold Schwarzenegger, as celebrity, and Rafael Gazetov, as worshipper, in terms of existing 100 dollar's banknote with arrangement of person's attributes of Rafael Gazetov, as purchaser, on the left.

FIG. 7A is scheme showing example of single design of independent compound person's attributes, independent compound legal entity's attributes, independent compound brands or independent compound currency (money) between Gerard Depardieu, as celebrity, and Liudmila Gazetova, as worshipper, in terms of existing 500 euro's banknote with arrangement of person's attributes of Liudmila Gazetova, as purchaser, on the left.

FIG. 7B is scheme showing example of single design of independent compound person's attributes, independent compound legal entity's attributes, independent compound brands or independent compound currency (money) between Gerard Depardieu, as celebrity, and Marina Gazetova, as worshipper, in terms of existing 500 euro's banknote with arrangement of person's attributes of Marina Gazetova, as purchaser, on the left.

FIG. 8A is scheme showing example of single design of independent compound person's attributes, independent compound legal entity's attributes, independent compound brands or independent compound currency (money) between Gerard Depardieu, as celebrity, and Liudmila Gazetova, as worshipper, in terms of existing 500 euro's banknote with arrangement of person's attributes of Liudmila Gazetova, as purchaser, on the right.

FIG. 8B is scheme showing example of single design of independent compound person's attributes, independent compound legal entity's attributes, independent compound brands or independent compound currency (money) between Gerard Depardieu, as celebrity, and Marina Gazetova, as worshipper, in terms of existing 500 euro's banknote with arrangement of person's attributes of Marina Gazetova, as purchaser, on the right.

FIG. 9A is scheme showing example of single design of independent compound spaces (duration) of time between David Backham, as celebrity, and Liudmila Gazetova, as worshipper, in terms of existing 20 pound's banknote with arrangement of person's attributes of Liudmila Gazetova, as purchaser, on the left.

FIG. 9B is scheme showing example of single design of independent compound spaces (duration) of time between David Backham, as celebrity, and Marina Gazetova, as worshipper, in terms of existing 20 pound's banknote with arrangement of person's attributes of Marina Gazetova, as purchaser, on the left.

FIG. 10 is scheme showing example of business method for person's or legal entity's compound attributes creation and marketing usage for Public Relations (PR) technologies.

### DETAILED DESCRIPTION OF THE PREFERRED EMBODIMENT

Next, with reference to the accompanying drawings, a person's or legal entity's compound attributes creation and marketing business method according to an embodiment of the present invention will be described.

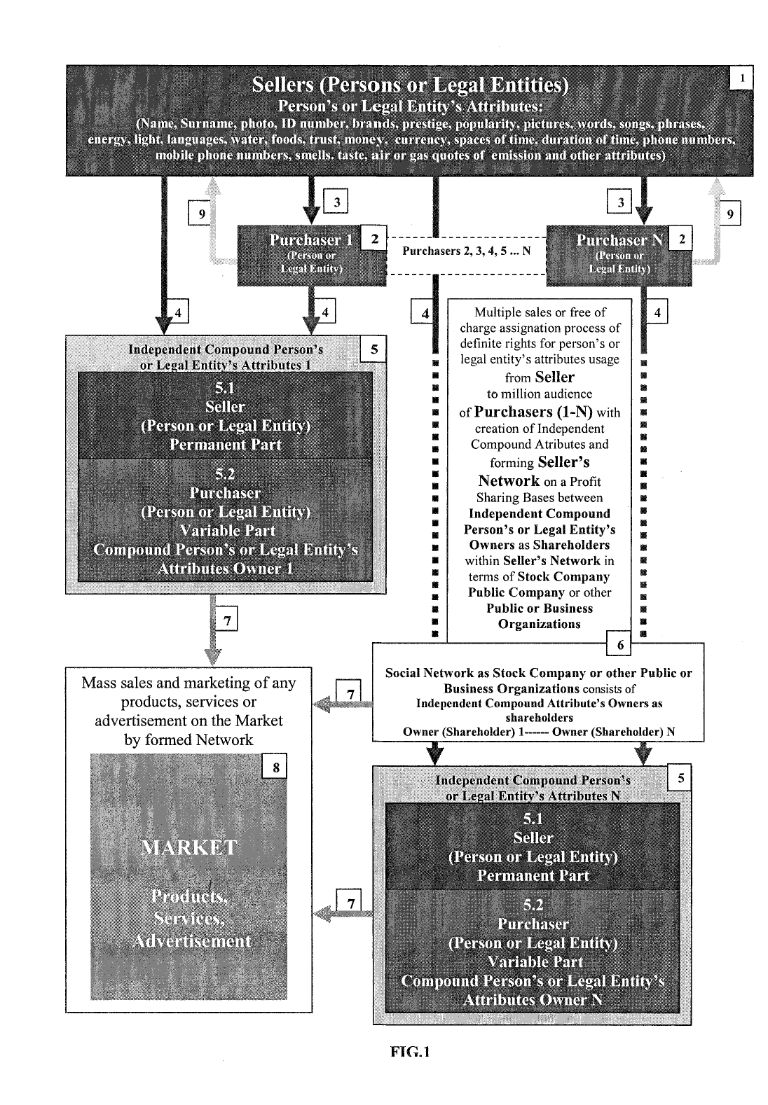

FIG. 1 is a comprehensive block-diagram showing the business process of creation and marketing of compound person's or legal entity's attributes according to an embodiment of the present invention.

FIG. 1 shows and explains the process of multiple sales or free of charge assignation and marketing of definite rights for person's or legal entity's attributes uses from sellers 1 to purchasers 2 with creation of compound person's or legal entity's attributes 5. Multiple sales or free of charge assignation process of definite rights for person's or legal entity's attributes uses from sellers 1 (blue colour) to purchasers 2 (red colour) shown by arrows 3 (blue colour), and creation process of independent compound person's or legal entity's attributes shown by arrows 4 (blue colour). Created compound product and instrument in terms of independent compound person's or legal entity's attributes 5 (yellow colour), which consists of permanent part 5.1 (blue marked) and variable part 5.2 (red marked). Permanent part 5.1 is labelled blue colour, and variable part 5.2 is labelled red colour and form compound person's or legal entity's attributes.

FIG. 1 shows multiple mass sales and marketing process of definite rights for person's or legal entity's attributes uses from sellers 1 to million audiences of purchasers(1-N) 2 with creation of compound person's or legal entity's attributes 5, wherein purchasers(1-N) 2 become new created compound person's or legal entity's attribute owners 5, which form social seller's network 6 on a profit sharing bases between independent compound person's or legal entity's attribute owners 5, as shareholders within seller's network, for example in terms of stock company, public company or other business or public organizations. By means of formed social seller's network 6 is provided by mass sales and marketing, shown by arrows 7 (green colour) any products, services or advertisement on the market 8, labelled green colour. A definite fees, as shown by arrows 9 (yellow colour), is paid to sellers by purchasers for rights of person's or legal entity's attributes uses.

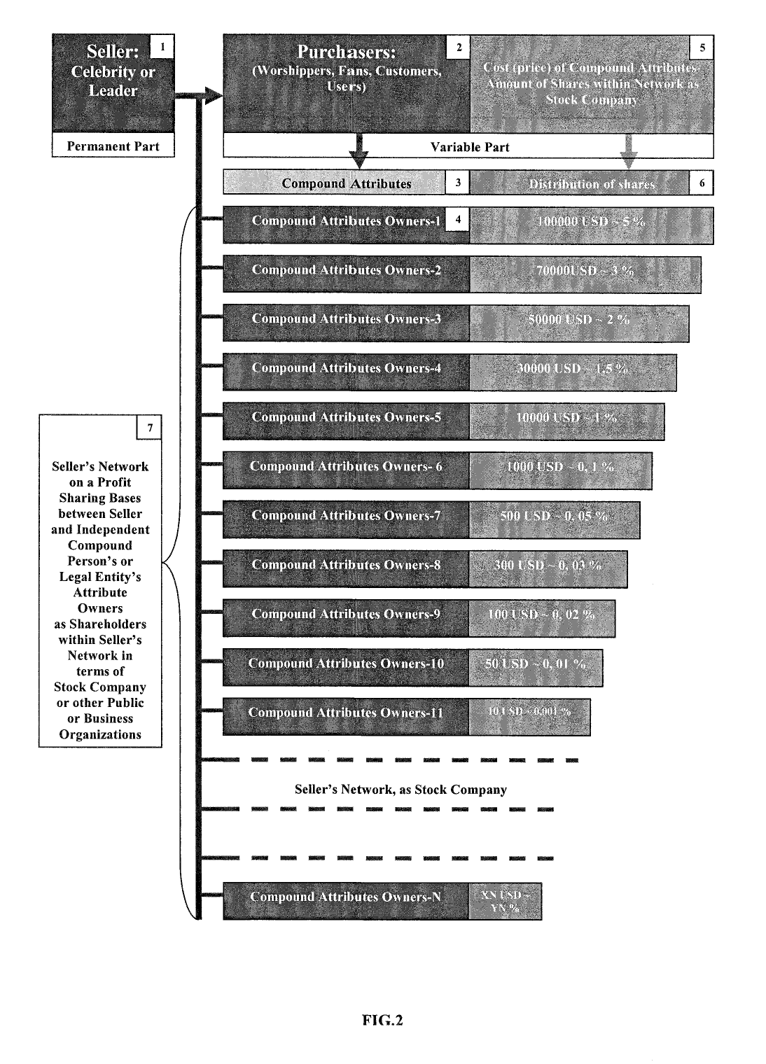

FIG. 2 is a comprehensive block diagram showing multiple sales or free of charge assignation and marketing process of definite rights for person's or legal entity's attributes uses from sellers 1 (blue colour) to million audience of purchasers 2 (red colour) with creation of compound person's or legal entity's attributes 3 (yellow colour). Purchasers 2 become independent compound person's or legal entity's attribute owners 4 (red colour) and forming seller's network on a profit sharing bases 5 (green colour) between independent compound person's or legal entity's attribute owners 4, as shareholders within seller's network 7, for example in terms of stock company, public company or other business or public organizations. Distribution of shares (percentage) 6 (green colour) is carried out proportionate to cost (price) 5 of definite rights for seller's attributes uses. For example seller 1, who is seller's network 7 (in terms of stock company or public company) owner desire to sale 30 percent of own stock company's shares to independent compound person's attribute owners 4. For example purchasers group 1 pay to seller 2 fee 100 000 USD of definite rights for seller's attribute uses and creation of compound person's attributes 3. For example fee 100 000 USD correspond to 5 percent of shares. Then, group of compound attributes owners-1 control 5% of shares within seller's network, for example in terms of stock company, public company or other business or public organizations. For example fee 70 000 USD correspond to 3 percent of shares. Then, group of compound attributes owners-2 control 3% of shares within seller's network. For example fee 1000 USD correspond to 0.1% percent of shares. Then, group of compound attributes owners-6 control 0.1% of shares within seller's network, for example fee 100 USD correspond to 0.02% percent of shares. Then, group of compound attributes owners-10 control 0.02% of shares within seller's network etc. Then, amount of shares within seller's network, as stock company, proportionate to the cost of compound attributes.

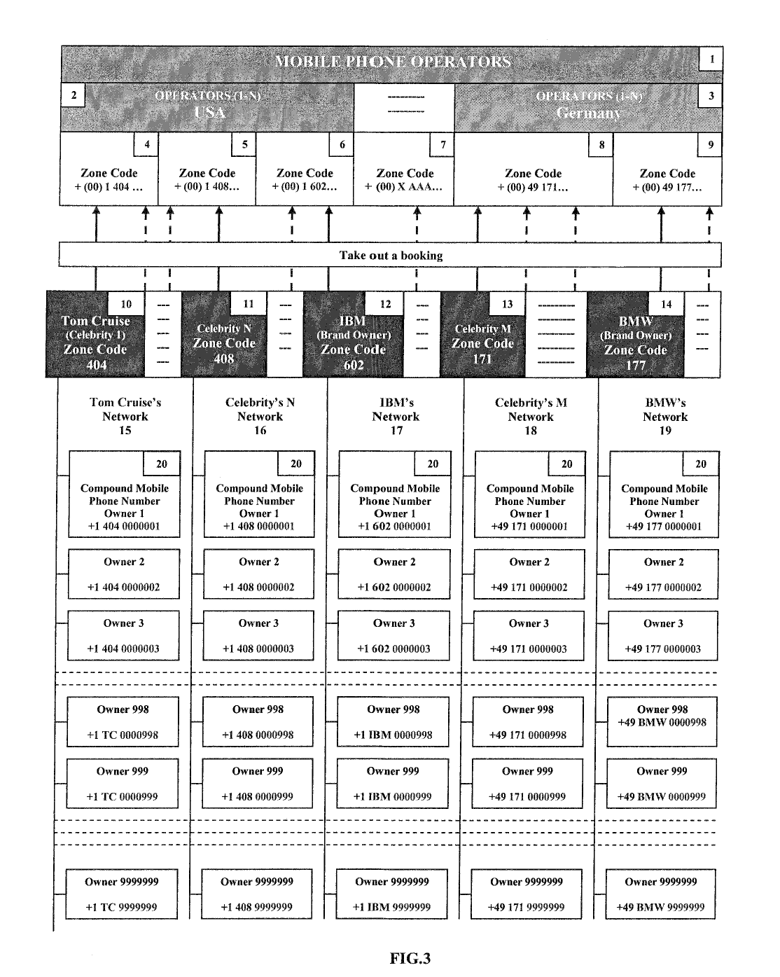

FIG. 3 shows and explains process of taking out a booking by celebrities 10, 11, 13 or brand name owners 12, 14 from mobile phone operators 1 and multiple sales or free of charge assignation of definite rights for mobile phone numbers uses from celebrities 10, 11, 13 or brand name owners 12, 14 to million audience of purchasers, fans, worshippers, customers, users or other clients with creation of compound mobile phone numbers and forming seller's network 15, 16, 17, 18, 19 on a profit sharing bases between independent compound mobile phone number owners 20, for example in terms of stock company, public company or other business or public organizations. In the first step: celebrities 10, 11, 13 or brand name owners 12, 14, for example Tom Cruise 1, celebrity N 11, IBM 12 take out a booking from USA mobile phone operator 2, and celebrity M 13 and BMW 14 take out a booking from German mobile phone operator 3 zone codes. Thus USA zone code 4 for Tom Cruise 1 is 404, USA zone code 5 for celebrity N is 408, USA zone code 6 for IBM 12 is 602, German zone code 8 for celebrity M 13 is 171, and German zone code 9 for BMW 14 is 177. In the second step: Tom Cruise 1 multiple sale or free of charge assignation of definite rights for mobile zone code 177 uses to million audience of purchasers with simultaneous creation of independent compound mobile phone numbers +1 404 0000001-9999999. Purchasers become independent compound mobile phone number owners 20 and form Tom Cruise's network 15 on a profit sharing bases between independent compound mobile phone number owners 20, as shareholders within Tom Cruise's network 20. For example USA mobile phone operator 2 converts zone code 404 to Tom Cruise under the same name, for example zone code 404 is converted to TC (Tom Cruise) and his fans and worshippers can use following compound mobile phone number +1 TC 0000998-9999999 etc; Celebrity N 11 multiple sale or free of charge assignation of definite rights for mobile zone code 408 uses to million audience of purchasers with simultaneous creation of independent compound mobile phone numbers +1 408 0000001-9999999. Purchasers become independent compound mobile phone number owners 20 and form celebrity's N 11 network 16 on a profit sharing bases between independent compound mobile phone number owners 20, as shareholders within celebrity's N 11 network 20; IBM 12 multiple sale or free of charge assignation of definite rights for mobile zone code 602 uses to million audience of purchasers with simultaneous creation of independent compound mobile phone numbers +1 602 0000001-9999999. Purchasers become independent compound mobile phone number owners 20 and form IBM's 12 network 17 on a profit sharing bases between independent compound person's or legal entity's attribute owners 20, as shareholders within IBM's network 20. For example USA mobile phone operator 2 converts the zone code 602 to IBM under the same name, for example zone code 602 is converted to IBM and his fans and worshippers can use following compound mobile phone number +1 IBM 0000998-9999999 etc; BMW 14 multiple sale or free of charge assignation of definite rights for mobile zone code 177 uses to million audience of purchasers with simultaneous creation of independent compound mobile phone numbers +1 177 0000001-9999999. Purchasers become independent compound mobile phone number owners 20 and form BMW's 14 network 19 on a profit sharing bases between independent compound person's or legal entity's attribute owners 20, as shareholders within BMW's network 20. For example German mobile phone operator 3 converts zone code 177 to BMW under the same name, for example zone code 177 is converted to BMW, and his fans and worshippers can use following compound mobile phone number +1 BMW 0000998-9999999 etc;

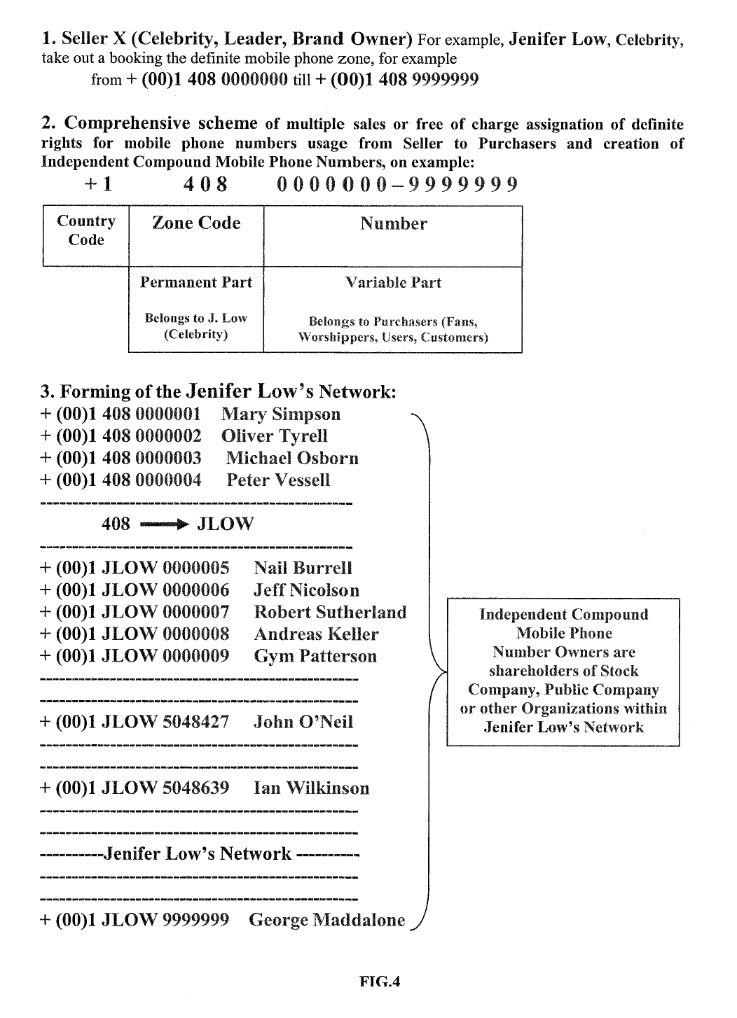

FIG. 4 shows comprehensive creation algorithm of compound mobile phone numbers and forming seller's network on a profit sharing bases between independent mobile phone number owners, as shareholders, within seller's network. On FIG. 4 clause 1, there is seller X, for example Jenifer Low, as celebrity and corresponding mobile phone zone code, for example +(00)1 408. FIG. 4 clause 2 shows comprehensive scheme of multiple sales or free of charge assignation of definite rights for mobile phone numbers uses from Jenifer Low to million audiences of purchasers with creation of independent compound mobile phone numbers +(00)1 408 0000001-9999999 and forming Jenifer Low's network. Purchasers, for example Mary Simpson, Oliver Tyrell, Michael Osborn, Peter, Vessell . . . George Maddalone etc, become independent compound mobile phone number owners. FIG. 4 clause 3 shows forming process of Jenifer Low's network, as stock company on a profit sharing bases between independent compound mobile phone number owners.

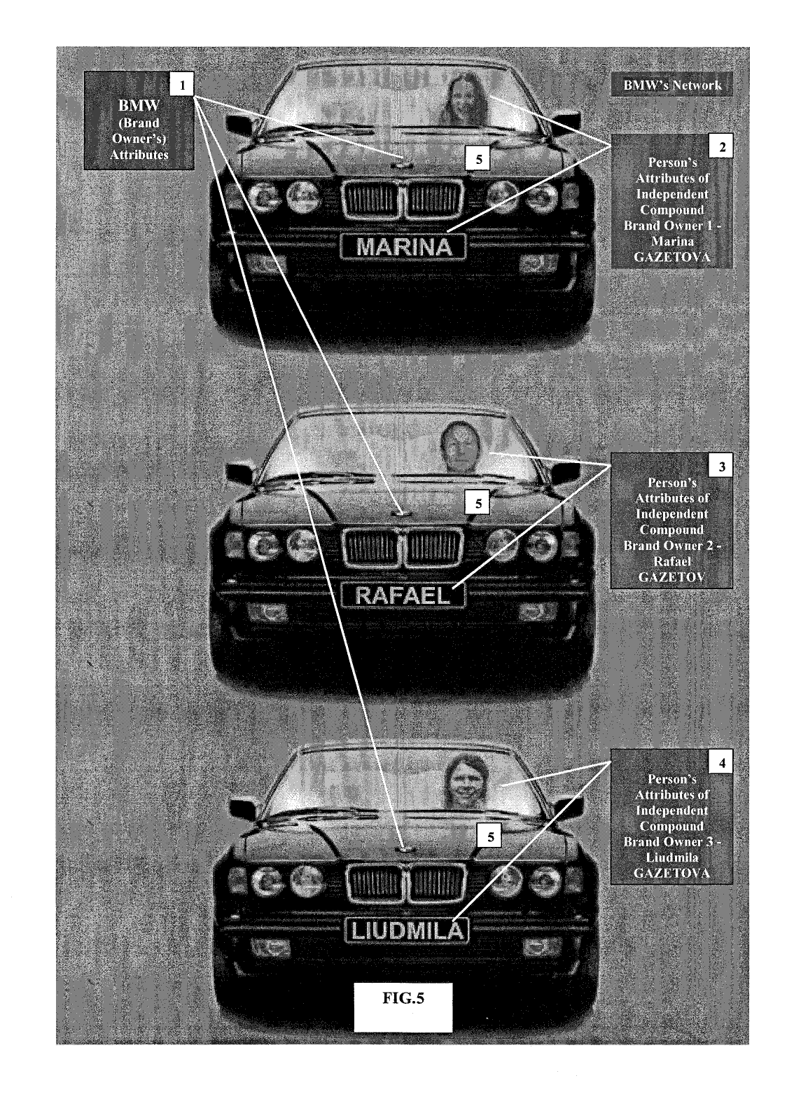

FIG. 5 shows and explains process of multiple sale or free of charge of definite rights for BMW's attributes uses from 1 to purchasers, Marina Gazetova 2, Liudmila Gazetova 3, Rafael Gazetov 4 etc, with simultaneous creation of compound brands 5 between famous brand name owner BMW 5 and Marina Gazetova 2, Liudmila Gazetova 3, Rafael Gazetov 4 etc, wherein purchasers become independent compound brand owners and forming BMW's network.

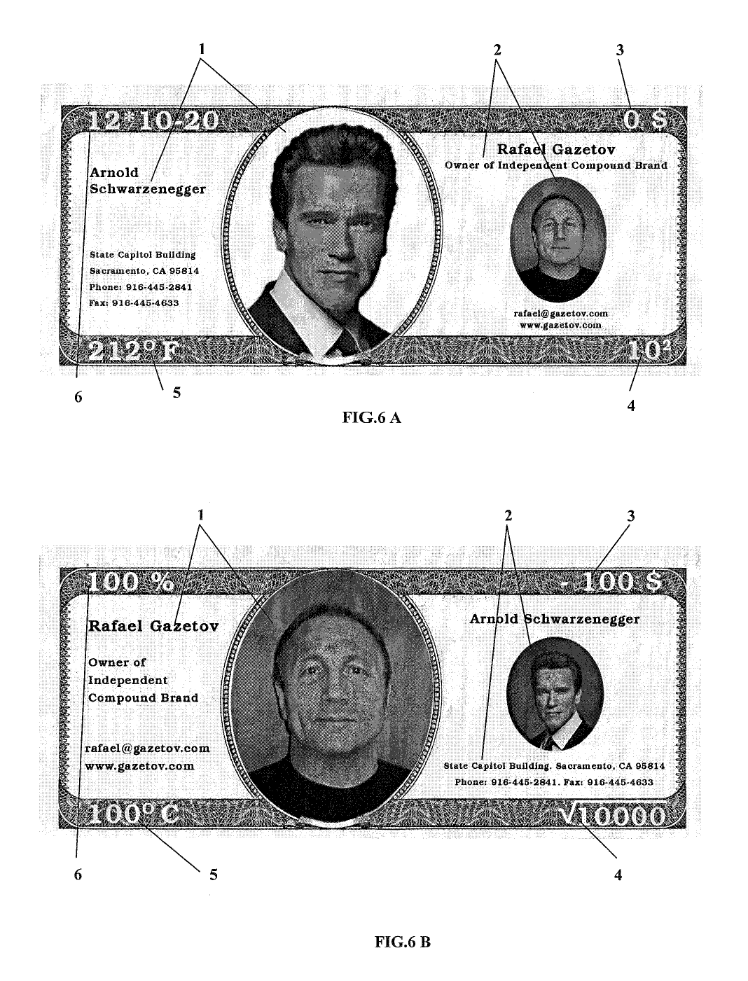

On FIG. 6A is shown example of independent compound brand in terms of independent compound money between Arnold Schwarzenegger, as celebrity, and Rafael Gazetov, as worshipper, in terms of existing 100 dollar's banknote. Permanent part—1 consist of person's attributes (photo, name, surname, phone, e-mails and other attributes) of Arnold Schwarzenegger, celebrity, is arranged on the left part. Variable part—2 consist of person's attributes (photo, name, surname, e-mails and other attributes) of Rafael Gazetov, worshipper, is arranged on the right part. Rafael Gazetov is owner of virtual independent compound money. Nominal cost of such virtual independent compound money could be expressed in any expressions or formula, for example zero $—3 or formula 10²—4 or 212 Fahrenheit degrees—5 or formula 12*10−20—6 or other.

On FIG. 6B is shown example of independent compound brand in terms of independent compound money between Arnold Schwarzenegger, as celebrity, and Rafael Gazetov, as worshipper, in terms of existing 100 dollar's banknote. Variable part—1 consists of person's attributes (photo, name, surname, e-mails and other attributes) of Rafael Gazetov, worshipper, is arranged on the left part. Permanent part—2 consist of person's attributes (photo, name, surname, phone, e-mails and other attributes) of Arnold Schwarzenegger, celebrity, is arranged on the right part. Rafael Gazetov is owner of virtual independent compound money. Nominal cost of such virtual independent compound money could be expressed in any expressions or formula, for example −100 $—3 or square root of 10000—4 or 100 Celsius degrees—5 or 100%—6 or other.

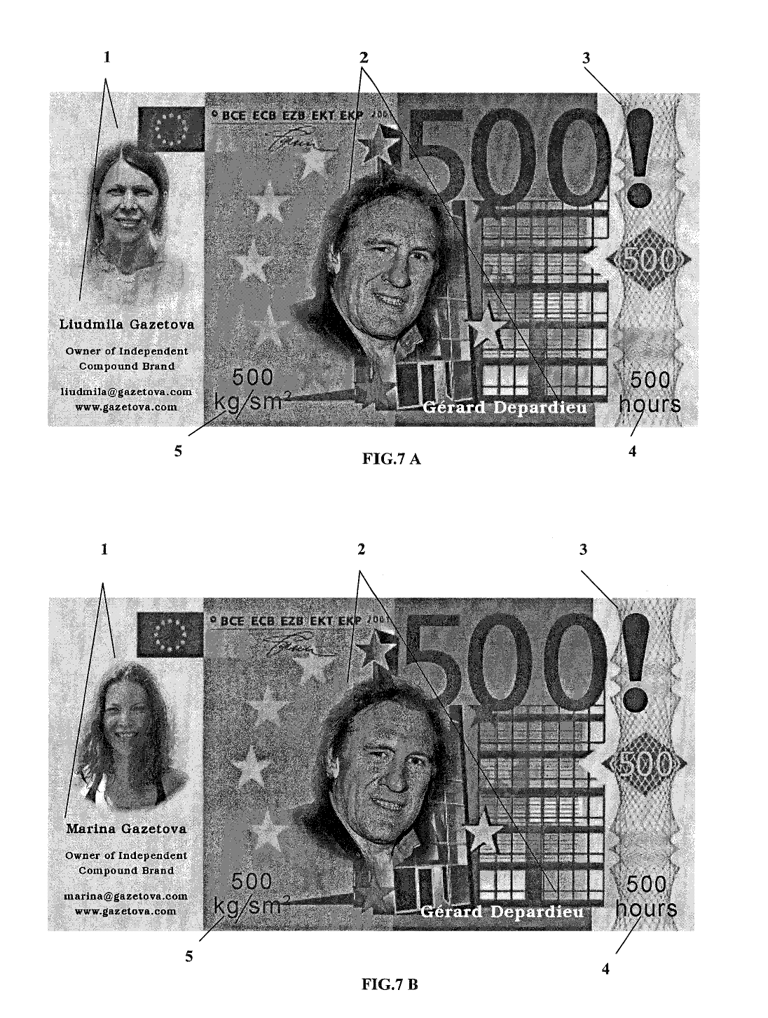

On FIG. 7A is shown example of independent compound brand in terms of independent compound money between Gerard Depardieu, as celebrity, and Liudmila Gazetova, as worshipper, in terms of existing 500 euro's banknote. Variable part—1 consists of person's attributes (photo, name, surname, e-mails and other attributes) of Liudmila Gazetova, worshipper, is arranged on the left part. Permanent part—2 consist of person's attributes (photo, name, surname, phone, e-mails and other attributes) of Gerard Depardieu, celebrity, is arranged on the right part. Liudmila Gazetova is owner of virtual independent compound money. Nominal cost of such virtual independent compound money could be expressed in any expressions or formula, for example 500! (Factorial)—3 or 500 hours—4 or 500 kg/sm²—5 or other.

On FIG. 7B is shown example of independent compound brand in terms of independent compound money between Gerard Depardieu, as celebrity, and Marina Gazetova, as other worshipper, in terms of existing 500 euro's banknote. Variable part—1 consist of person's attributes (photo, name, surname, e-mails and other attributes) of Marina Gazetova, worshipper, is arranged on the left part. Permanent part—2 consist of person's attributes (photo, name, surname, phone, e-mails and other attributes) of Gerard Depardieu, celebrity, is arranged on the right part. Marina Gazetova is owner of virtual independent compound money. Nominal cost of such virtual independent compound money could be expressed in any expressions or formula, for example 500! (Factorial)—3 or 500 hours—4 or 500 kg/sm²—5 or other.

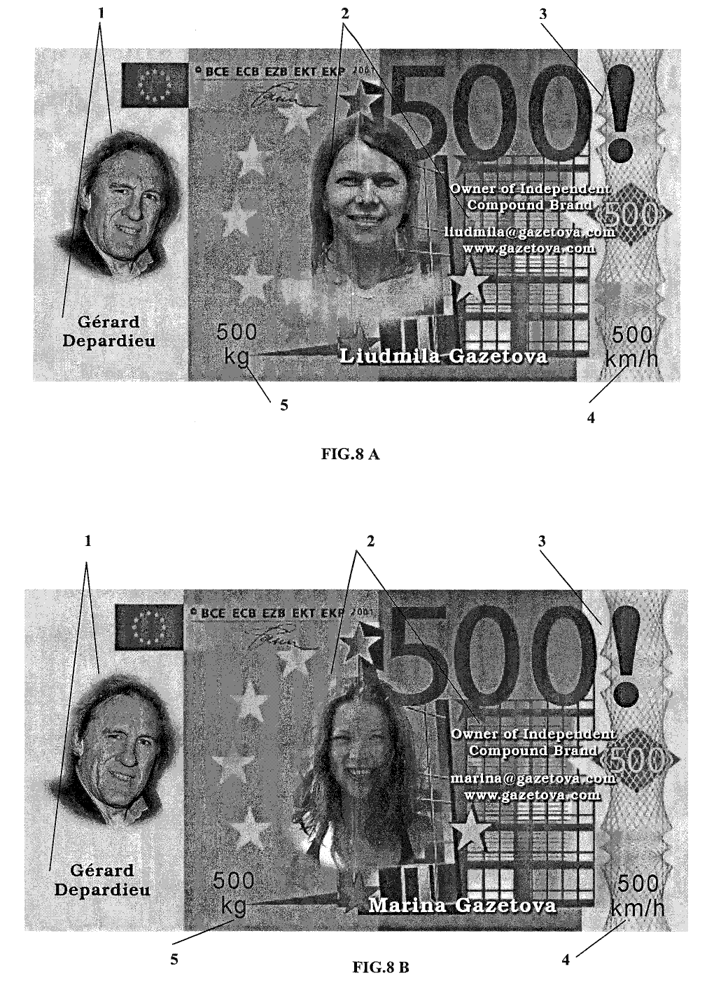

On FIG. 8A is shown example of independent compound brand in terms of independent compound money between Gerard Depardieu, as celebrity, and Liudmila Gazetova, as worshipper, in terms of existing 500 euro's banknote. Permanent part—1 consist of person's attributes (photo, name, surname and other attributes) of Gerard Depardieu, celebrity, is arranged on the left part. Variable part—2 consist of person's attributes (photo, name, surname, e-mails and other attributes) of Liudmila Gazetova, worshipper, is arranged on the right part. Liudmila Gazetova is owner of virtual independent compound money. Nominal cost of such virtual independent compound money could be expressed in any expressions or formula, for example 500! (Factorial)—3 or 500 km/h—4 or 500 kg—5 or other.

On FIG. 8B is shown example of independent compound brand in terms of independent compound money between Gerard Depardieu, as celebrity, and Marina Gazetova, as worshipper, in terms of existing 500 euro's banknote. Permanent part—1 consist of person's attributes (photo, name, surname and other attributes) of Gerard Depardieu, celebrity, is arranged on the left part. Variable part—2 consist of person's attributes (photo, name, surname, e-mails and other attributes) of Marina Gazetova, worshipper, is arranged on the right part. Marina Gazetova is owner of virtual independent compound money. Nominal cost of such virtual independent compound money could be expressed in any expressions or formula, for example 500! (Factorial)—3 or 500 km/h—4 or 500 kg—5 or other.

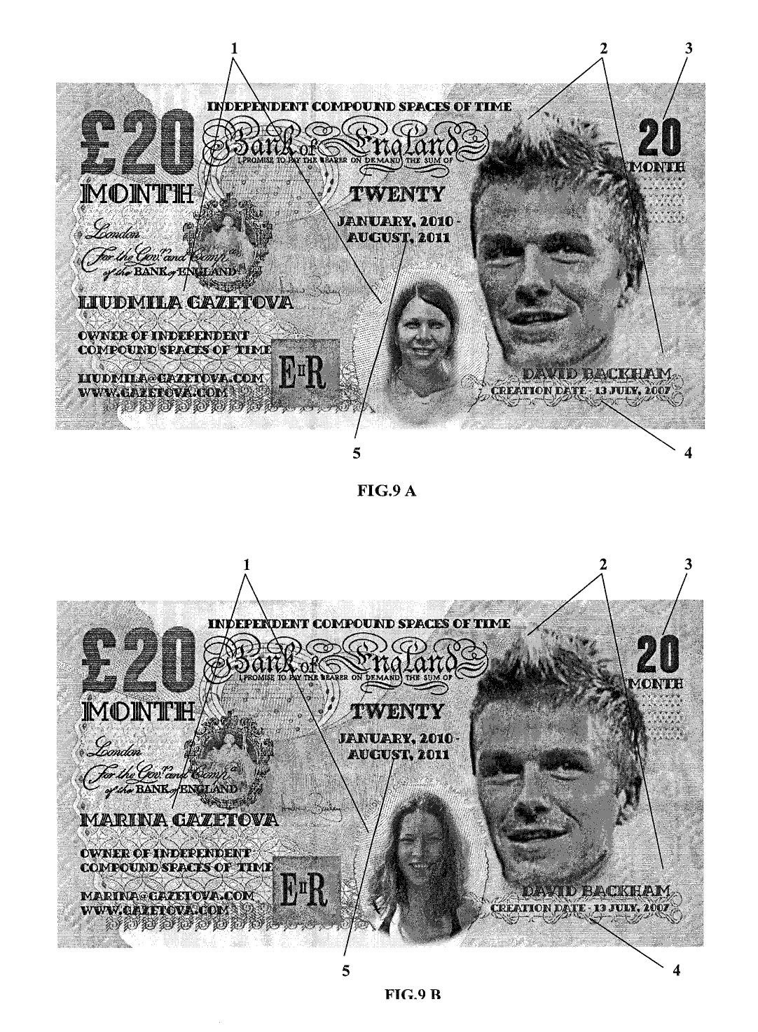

On FIG. 9A is shown example of independent compound spaces of time between David Backham, as celebrity, and Liudmila Gazetova, as worshipper, in terms of existing 20 pound's banknote. Variable part—1 consist of person's attributes (photo, name, surname and other attributes) of Liudmila Gazetova, worshipper, is arranged on the left part. Permanent part—2 consist of person's attributes (photo, name, surname, e-mails and other attributes) of David Backham, celebrity, is arranged on the right part. Liudmila Gazetova is owner of virtual independent compound spaces of time. Nominal cost of such virtual independent compound spaces of time could be expressed in terms of any spaces of time (minutes, hours, days, weeks, months, years etc.), for example 20 months—3. Also, is named the exact day of independent compound spaces time creation (creation date—13 Jul., 2007)—4 and joint created spaces of time (validity) 20 months (from January, 2010 till August, 2011)—5 in future between David Backham, as celebrity and Liudmila Gazetova, as worshipper.

On FIG. 9B is shown example of independent compound spaces of time between David Backham, as celebrity, and Marina Gazetova, as worshipper, in terms of existing 20 pound's banknote. Variable part—1 consist of person's attributes (photo, name, surname and other attributes) of Marina Gazetova, worshipper, is arranged on the left part. Permanent part—2 consist of person's attributes (photo, name, surname, e-mails and other attributes) of David Backham, celebrity, is arranged on the right part. Marina Gazetova is owner of virtual independent compound spaces of time. Nominal cost of such virtual independent compound spaces of time could be expressed in terms of any spaces of time (minutes, hours, days, weeks, months, years etc.), for example 20 months—3. Also, is named the exact day of independent compound spaces time creation (creation date—13 Jul., 2007)—4 and joint created spaces of time (validity) 20 months (from January, 2010 till August, 2011)—5 in future between David Backham, as celebrity and Marina Gazetova, as worshipper.

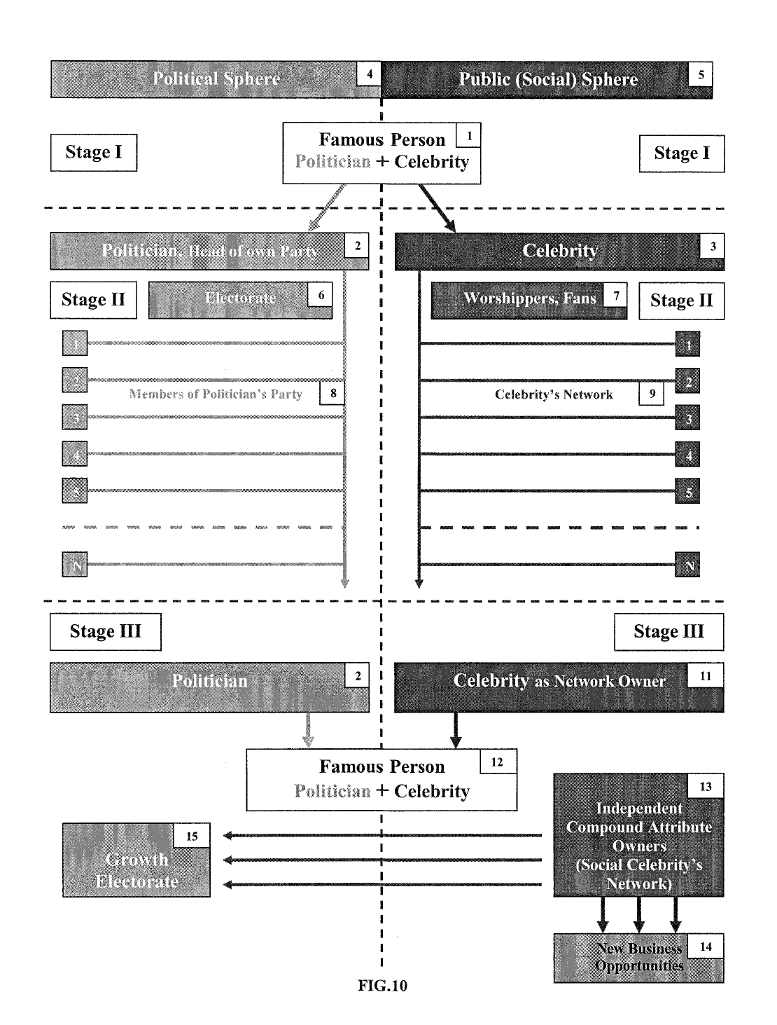

FIG. 10 shows and explain example of business method for person's or legal entity's compound attributes creation and marketing usage in Public Relations (PR) technologies. FIG. 10 stage I: There is famous person 1, who combines in himself politician 2 (green colour) and celebrity 3 (blue colour). Any politician wishes to increase own popularity and can use this business method person's or legal entity's compound attributes creation and marketing for promote pre-election PR campaign and increase own electorate 6 (green colour). FIG. 10 stage II: Such famous person 1 is divided virtually on two persons, namely: as politician 2 and celebrity 3. Celebrity 3 is considered himself in the society in public sphere 5 (blue colour) not like politician in political sphere 4 (green colour), but like celebrity 3 and apply to the own audience not like to the electorate 6 but like to own fans, worshippers 7 (red colour) and create independent compound person's attributes, for example independent compound brands, currency, money, spaces (duration) of time or other independent compound attributes with all own worshippers, fans 7. Thus, transition from the political sphere 4 of relationships between politicians 2 and his electorate 6 happens to the society sphere 5 of relationships between celebrity 2 and his worshippers 7 happen. As a result, famous person 1 who is considering himself as a celebrity 3 a powerful human resource is appearing in terms of created social celebrity's network 9 (red colour). FIG. 10 Stage III: Celebrity's network 9 consists of numerous quantities of independent compound brand, money, spaces of time or other compound attribute owners 13 (red colour) within social celebrity's network. In this stage, virtually divided famous person 1 is combined again, namely: famous person 1=politician 2+celebrity 3. This famous person 1 as celebrity network owner 11 (blue colour) can use such human recourses before election and to appeal all own independent compound brand, money, spaces of time or other attribute owners 13 to vote for him and to reach growth electorate 15 (green colour) or reorganize own social celebrity's network 13 to the political party 8 (green colour) and to reach own political goals. In case of political failure, such famous person, as celebrity possesses own network and will have new business opportunities 14 (orange colour).

### EXAMPLES

Example 1 of business method for person's or legal entity's compound attributes creation and marketing usage (FIG. 3, 4): An example of independent compound brand design is independent compound mobile phone numbers between celebrities, leaders or brand name owners and their worshippers, fans, customers or other clients. In the first step, any celebrity, leader, or brand name owner, for example Tom Cruise, IBM and BMW, take out a booking with one's mobile phone operators zone codes (FIG. 3), for example USA zone code for Tom Cruise is 404, USA zone code for celebrity N is 408, German zone code for celebrity N is 171, German zone code for BMW is 177. In the second step, Tom Cruise, IBM, BMW and other celebrities N or brand name owners multiple sales or free of charge assignation (FIG. 4) of definite rights for mobile phone numbers uses to million audience of purchasers with simultaneous creation of independent compound mobile phone numbers. Purchasers become independent compound mobile phone number owners within celebrity's' zone code and form seller's network on a profit sharing bases between independent compound person's or legal entity's attribute owners, as shareholders, within seller's network. Mobile phone operators can to give zone code to celebrities or brand name owners of the same names, for example: instead of created compound mobile phone number +1 404 0000000-9999999 between Tom Cruise (TC) and his fans and worshippers can be use compound mobile phone number +1 TC 000000-9999999; instead of created compound mobile phone number +1 602 000000-9999999 between IBM and his customers, can be use compound mobile phone number +1 IBM 0000000-9999999; instead of +49 177 000000-9999999 can be use compound mobile phone number +1 BMW 0000000-9999999.

Example 2 of business method for person's or legal entity's compound attributes creation and marketing usage (FIG. 6A, 6B, 7A, 7B, 8A, 8B): An example of independent compound brand design is virtual banknotes, currency, money, coins, bank credit cards or any capital issues as most mass and low cost-plus channel of communication in the social reputation (popularity) networks, which is inevitably met by celebrities and worshippers every day. These are ideal carriers of culture, advertising, declaration of ideological principles propaganda for celebrities in own created social networks consisted of many worshippers. One design of independent compound brands in terms of virtual banknotes, currency with idol image and own image alongside arouses in the consciousness of their owners strong feel of possession of huge capital even only virtual, which is overlap to the feeling of belonging to the elite, famous and popular people and brands. Such compound virtual currency (money) has a value because worshippers believe in their celebrities and accordingly trust to this virtual compound currency (money). Independent compound brands in terms of virtual banknotes is a unusual and attractive internal networking economical system which is based on culture and trusting to one or other brand, which serves as nonmaterial cultural exchange way, expression of trust or gratitude and can operate as “People's Currency” in the social celebrity's network. Such “People's Currency” are powerful network resource is wholly and completely in the hands of celebrities or brand owners for managing of their networks. Own celebrity's attributes on the banknotes together with attributes of worshippers compel worshippers to touch these banknotes every day many times. Such independent compound brands in the form of banknotes are the ideas presentation form for celebrities. For example, for prosper worshippers the image of hundred dollar banknote is a symbol of business, success and finance stability. One of main attributes for social reputation networks can be virtual compound currency (banknotes, money) as symbol, which expresses and supports ideas of compound brand creation. Such virtual compound currency (banknotes, money) and coins combine attributes of sellers (celebrities or other leaders) and purchasers (worshippers, consumers, users etc.) and can be employed inside social network of any celebrity, and can be exchanged between each other by worshippers as independent compound brand owners expressing definite attitude toward each other. Also, virtual compound currency (banknotes, money) can be exchanged between networks of different celebrities or other leaders. Thus, the biggest benefits and profits for sellers and purchasers will be if the background for single design of independent compound brands will be accepted the design of existed currency (banknotes, money, coins, capital stocks, obligations, or any other capital issues with face value, also bank credit cards, postage stamp and other) with zero, positive, negative values as measurement units of virtual cost for such virtual compound banknotes. These values can be presented as formula and expressions, for example mathematical or physical formula, numbers of elements, square or cube root of numbers, N power of numbers, Ig N, In N, N! (factorial) and other measurements units, for example N years, N kg, N tones, N kg/sm², N atmosphere, N Celsius degrees, N Fahrenheit degree, N pixels, N hours, N light years etc. The banknotes of 500 Euro or 100 dollars can be an example of single design of independent compound brand. For example on FIG. 6A, instead of B. Franklin, former USA President, photo on the 100 dollars banknote, Arnold Schwarzenegger, as celebrity (seller), image can be placed. On the left part of this compound currency Arnold Schwarzenegger's attributes can be placed, for example name, surname, domain names, e-mail addresses and other attributes. Permanent part of this compound banknote contains of Arnold Schwarzenegger's attributes. Instead of 100 on this banknote, Rafael Gazetov, as worshipper (purchaser), image can be placed. On the right part of this compound currency Rafael Gazetov attributes can be placed, for example name, surname, domain names, e-mail addresses and other attributes. Variable part of this compound banknote contains of Rafael Gazetov attributes. On FIG. 6B, instead of B. Franklin, former USA President, photo on the 100 dollars banknote, Rafael Gazetov, as worshipper (purchaser), image can be placed. On the left part of this compound currency Rafael Gazetov's attributes can be placed, for example name, surname, domain names, e-mail addresses and other attributes. Instead of 100 on this banknote, Arnold Schwarzenegger, as celebrity (seller), image can be placed. On the right part of this compound currency Arnold Schwarzenegger attributes can be placed, for example name, surname, domain names, e-mail addresses and other attributes. Other design solution of independent compound currency on the background hundred dollars banknote could be following: two pictures together of celebrity (seller) on the right and worshipper ((purchaser) on the left instead of B. Franklin picture. Allocation of celebrity's and worshipper's attributes could be the same as described above. Thus, the permanent part of all celebrity (seller) attributes is without changes, and labels, pictures and signs of variable part could be changed. Other examples on FIG. 7A, 7B, 8A, 8B, wherein instead of picture within ring consists of stars on the 500 Euros banknote, Gerard Depardieu, as celebrity (seller), image can be placed. On the rights part of this compound currency (FIG. 7A, 7B) Gerard Depardieu's attributes can be placed, for example his name, surname, domain names, e-mail addresses and other attributes. Permanent part of this compound banknote contains of Gerard Depardieu's attributes. On the left side on this 500 Euros banknote, Liudmila Gazetova (FIG. 7A) and Marina Gazetova (FIG. 7B) as worshippers (purchasers), images can be placed. On the right side of this compound currency Gerard Depardieu's attributes can be placed, for example his name, surname, domain names, e-mail addresses and other attributes. Variable part of this compound banknote contains of Liudmila Gazetova's attributes (FIG. 7A) or Marina Gazetova's attributes. On FIG. 8A, 8B, wherein instead of picture within ring consists of stars on the 500 Euros banknote, Liudmila Gazetova (FIG. 8A) or Marina Gazetova (FIG. 8B), as worshippers (purchasers), images can be placed. On the right side of this compound currency Liudmila Gazetova's (FIG. 8A) or Marina Gazetova's (FIG. 8B) attributes can be placed, for example their names, surnames, domain names, e-mail addresses and other attributes. On the left side of this compound currency (FIG. 8A, 8B) Gerard Depardieu's attributes can be placed, for example his name, surname, domain names, e-mail addresses and other attributes. Permanent part of this compound banknote contains of Gerard Depardieu's attributes. On the right side on this 500 Euros banknote, Liudmila Gazetova (FIG. 8A) and Marina Gazetova (FIG. 8B) as worshippers (purchasers), images can be placed. Variable part of this compound banknote contains of Liudmila Gazetova's attributes (FIG. 8A) or Marina Gazetova's (FIG. 8B) attributes. Herewith, any website visitor can monitor traffic of such virtual compound banknote as independent compound brand, checking if such banknotes have notes from former banknote's owner; can found out who was former owner of these banknotes some time ago, to see overcame way and to find out the distance, time in the way and average speed. Each virtual compound banknote will have own network and internet work map of its way. Above described example of business method for compound currency, money creation and marketing usage performs to create compound financial networks, as stock companies or other financial organizations, for example compound banks, between any celebrities, leaders or brand name owners and their worshippers, fans, customers or other clients, who are became independent compound bank owners.

Example 3 of business method for person's or legal entity's compound attributes creation and marketing usage (FIG. 9A, 9B): Other example of independent compound brand usage is independent compound spaces (duration) of time. Any sellers and purchasers can create independent compound spaces (duration) of time between them. Sellers become independent compound spaces (duration) of time owners. In other cases, purchasers could be become compound person's or legal entity's attribute owners also. An example of independent compound spaces (duration) of time design based on existing design of virtual currency, banknotes, coins, bank credit cards or capital issues, or could be developed special design of compound spaces (duration) of time certificate as Time Employment Certificate where, beside attributes of sellers and purchasers, current time of using rights for spaces (duration) of time selling, time of creation of independent compound spaces (duration) of time, and also exact time in the future where purchaser have a right to use spaces (duration) of time could be displayed. For example, celebrity (seller) provides either multiple sales or free of charge assignation of own spaces (duration) of time, as personal attributes, to worshippers (purchasers) with simultaneous creation of independent compound spaces (duration) of time between them. Worshippers become independent compound spaces (duration) of time owners and they have definite rights to uses those spaces of time (validity) in future, an example for resale, advertisement or other activities. And vice versa, celebrity or brand name owner can buy definite rights to uses spaces (duration) of time from worshippers and become compound spaces (duration) of time owner. For example, company N purchases definite rights from own employees or third-party experts to use their spaces of time in the future, for example in period of time from January, 2010 till December, 2010 and create compound spaces (duration) of time them. Company N, as compound spaces (duration) of time owner, in this period of time desires to engage these specialists and experts for implementation in any projects, even they are not company's employees any more. Availability of these experts or specialists is ensured to company N by created compound spaces of time certificates. Other example (FIG. 9A, 9B), David Backham, as celebrity (seller), provides either multiple sales of own spaces (duration) of time, as personal attributes, to Liudmila Gazetova (FIG. 9A) and Marina Gazetova (FIG. 9B), as worshippers (purchasers), with simultaneous creation of independent compound spaces (duration) of time between them on bases of existing design of Great Britain Pound. Liudmila Gazetova (FIG. 9A) and Marina Gazetova (FIG. 9B) become independent compound spaces (duration) of time owners and they have definite rights to uses those spaces of time (validity) in future, for example in period of time from January, 2010 till December, 2010 for resale, advertisement or other usage. For example, David Backham's attributes are arranged on the right side, and Liudmila Gazetova (FIG. 9A) and Marina Gazetova (FIG. 9B) attributes are arranged on the left side. Is indicated creation date of Independent compound spaces (duration) of time also, for example 13, Jul., 2007. Factually, this method lets implement sellers and purchasers time stocking and create Compound Spaces of Time Market and Compound Spaces of Time Exchange accordingly. On such Compound Spaces of Time Exchange, spaces (duration) of time of any sellers and their purchasers, included in social networks of sellers can circulate easily. Proposed method lets to implement spaces (duration) of time transformation within social networks and spaces (duration) of time transformation between social networks and to fulfill temporary investments to specified people for better usage of spaces (duration) of time in the future. Proposed method lets to implement conversion of the past and present time to the future.

Example 4 of business method for person's or legal entity's compound attributes creation and marketing usage: Let's study an example of business method for person's or legal entity's compound attributes creation and marketing usage for Public Relations (PR) technologies. Stage I (FIG. 10): Any popular politician is famous person and combines in himself politician and celebrity simultaneously. Any politician wishes to increase own popularity and can use this business method person's or legal entity's compound attributes creation and marketing for promote pre-election PR campaign and increase own electorate. Stage II: Such famous person, as celebrity, can consider himself in the society not like politician, but like celebrity and apply to the own audience not like to the electorate but like to own fans, worshippers and create independent compound person's attributes, for example independent compound brands, currency, money, spaces (duration) of time or other independent compound attributes with all own worshippers, fans. Thus, transition from the political sphere of relationships between politicians—electorate happens to the society sphere of relationships between celebrities—worshippers happen. As a result, politician who is considering himself as a celebrity a powerful human resource is appearing in terms of created social celebrity's network, consisted of numerous quantity of independent compound brand, money, spaces of time or other attribute owners. Stage III: Such politician can use such human recourses before election and to appeal all own independent compound brand, money, spaces of time or other attribute owners to vote for him or reorganize own social network to the political party and to reach own political goals. In case of political failure, such famous person, as celebrity possesses own network and will have new business opportunities.

### New Opportunities for Applied Fields

The business method for compound attributes creation and marketing gives new opportunities for famous persons, celebrities, leaders or any brand owners and their fans or worshippers and can be use for applied fields and technologies, for example PR technologies, human resources management technologies, investment technologies, financial technologies or other fields.

The business method for compound attributes creation and marketing gives right motivations for employed top managers so that they earn money for both the capital owner and themselves without mixing up their personal and corporative interests. It helps to relate the motivations of top managers to the company's indexes, i.e. shareholders' capital.

The business method for compound attributes creation and marketing allows to motivate all top managers as leaders of other specialists that trust them and to create independent compound attributes with them, that would form their own network consisting of specialists in different fields, and to harmonically combine interests of all top managers at the same time. Then every company that wishes to employ an expert top manager has an opportunity to employ a whole management team by offering shares in the business. Such harmonious team can get into work straight away without wasting time on building relationships and creating positive atmosphere within the company. Then the risks of the managers team and the shareholders team will be maximally diminished and the growth of top managers' and their teams' earnings, as network business, will depend directly on the growth of shareholders' welfare.

Business method for compound attributes creation and marketing allows leaders and their worshippers to invest into each other on mutually conditions and to create network business. If the level of leader's popularity, reputation and trust among his worshippers is high, then it allows creation of different business networks, for example, investment companies, banks, or other financial institutions.

1. A method of creating and marketing compound attributes, comprising the steps of:
performing multiple assignations of definite rights for a use of a person's or a legal entity's attributes from sellers to purchasers,
each assignation including creation of compound person's or legal entity's attributes, and
each assignation including making the purchasers become owners of the created compound person's or legal entity's attributes; and
providing the created compound rights in a form perceivable to the respective purchaser of each created compound right.

2. The method of claim 1, wherein the multiple assignation of definite rights is performed free of charge.

3. The method of claim 1, wherein the multiple assignation of definite rights is performed for a sales charge.

4. The method of claim 1, wherein the multiple assignation of definite rights for a use of a person's or a legal entity's attributes from sellers to the purchasers, includes at least one assignation taken from the group consisting of:
from persons to persons;
from legal entities to persons;
from persons to legal entities, and
from legal entities to legal entities.

5. The method of claim 4, wherein the creation of the compound person's or legal entity's attributes, includes at least one creation taken from the group consisting of:
independent compound brands, pictures, intellectual properties, properties, rights, place, space, money, currency, spaces of time, duration of time, phone numbers, mobile phone numbers, words, phrases, songs, languages, energy, light, sound, water, foods, smells, air or gas quotes of emission, goods, services or other compound attributes.

6. The method of claim 4, wherein the creation of the compound person's or legal entity's attributes, includes at least one creation taken from the group consisting of:
independent compound brands, pictures, intellectual properties, properties, rights, place, space, money, currency, spaces of time, duration of time, phone numbers, mobile phone numbers, words, phrases, songs, languages, energy, light, sound, water, foods, smells, air or gas quotes of emission, goods, services or other compound attributes and
compound attributes between of the group consisting of:
independent compound brands, pictures, intellectual properties, properties, rights, place, space, money, currency, spaces of time, duration of time, phone numbers, mobile phone numbers, words, phrases, songs, languages, energy, light, sound, water, foods, smells, air or gas quotes of emission, goods, services or other compound attributes.

7. The method of claim 1, wherein,
for at least some assignations, also making the sellers become owners of the created compound person's or legal entity's attributes.

8. The method of claim 1, wherein,
the created compound attributes comprises a permanent part and a variable part,
the permanent part being united with the variable part as a single recognizable symbol of definite design,
the permanent part contains the person's or legal entity's attributes of the sellers,
the permanent part is arranged in a first part the symbol,
the variable part contains person's or legal entity's attributes of the purchasers, and
the variable part is arranged in a second part of the symbol,
the first and second parts of the symbol are different parts of the symbol, and
the single symbol comprises at least one of a visual symbol, a virtual symbol, and a sound symbol.

9. The method of claim 8, wherein the single symbol comprises at least two of the visual symbol, the virtual symbol, and the sound symbol.

10. The method of claim 9, wherein the single symbol comprising at least one of the visual symbol, the virtual symbol, and the sound symbol includes any of definite shapes, dimensions, colors, color background, sounds, sound background, light, energy, spaces of time, durations of time, existing design of brands, denominations, currency, money, banknotes, coins, bank credit cards, capital issues, designs with zero, negative or positive measurement units by way of mathematic, physical or other expressions or formula or any other design.

11. The method of claim 8, wherein,
the permanent part contains the person's or legal entity's attributes of the sellers, including at least one of the sellers' names, surnames, identification numbers, images, pictures, brands, trade marks, logotypes, intellectual properties, properties, rights, place, space, popularity, reputation, trust, prestige, money, currency, phone numbers, mobile phone numbers, spaces of time, duration of time, sound, words, phrases, songs, languages, energy, light, water, foods, smells, taste, air or gas quotes of emission and other person's or legal entity's attributes of sellers, and
the variable part contains person's or legal entity's attributes of the purchasers, including at least one of the purchasers' names, surnames, identification numbers, images, pictures, brands, trade marks, logotypes, intellectual properties, properties, rights, place, space, popularity, reputation, trust, prestige, money, currency, phone numbers, mobile phone numbers, spaces of time, duration of time, words, phrases, songs, sound, energy, light, water, food, smells, taste, air or gas quotes of emission and other person's or legal entity's attributes of purchasers.

12. The method of claim 1, comprising the further step of:
forming a seller's network of the compound person's or legal entity's attribute owners, wherein the owners are shareholders within the seller's network.

13. The method of claim 12, wherein,
the seller's network has the form of one of i) a stock company, ii) a public company, and iii) an organization on a profit sharing bases between shareholders, and
an amount of shares proportionate to each shareholder is determined based on a cost of definite rights for that seller's attributes uses.

14. A method of creating and marketing compound attributes, comprising the steps of:
performing multiple assignations of definite rights for a use of a person's or a legal entity's attributes from sellers to purchasers,
each assignation including creation of compound person's or legal entity's attributes, and
each assignation including making the purchasers become owners of the created compound person's or legal entity's attributes, wherein,
the created compound attributes comprises a permanent part and a variable part,
the permanent part being united with the variable part as a single recognizable symbol of definite design,
the permanent part contains the person's or legal entity's attributes of the sellers,
the permanent part is arranged in a first part the symbol,
the variable part contains person's or legal entity's attributes of the purchasers, and
the variable part is arranged in a second part of the symbol,
the first and second parts of the symbol are different parts of the symbol, and
the single symbol comprises at least one of a visual symbol, a virtual symbol, and a sound symbol; and
providing the created compound rights in a form perceivable to the respective purchaser of each created compound right.

15. The method of claim 14, wherein,
for at least some assignations, also making the sellers become owners of the created compound person's or legal entity's attributes.

16. The method of claim 14, wherein,
the creation of the compound person's or legal entity's attributes, includes at least one creation taken from the group consisting of:
independent compound brands, pictures, intellectual properties, properties, rights, place, space, money, currency, spaces of time, duration of time, phone numbers, mobile phone numbers, words, phrases, songs, languages, energy, light, sound, water, foods, smells, air or gas quotes of emission.

17. The method of claim 14, wherein the single symbol comprises at least two of the visual symbol, the virtual symbol, and the sound symbol.

18. The method of claim 14, wherein the single symbol comprising at least one of the visual symbol, the virtual symbol, and the sound symbol includes any of definite shapes, dimensions, colors, color background, sounds, sound background, light, energy, spaces of time, durations of time, existing design of brands, denominations, currency, money, banknotes, coins, bank credit cards, capital issues, designs with zero, negative or positive measurement units by way of mathematic, physical or other expressions or formula or any other design.

19. The method of claim 14, wherein,
the permanent part contains the person's or legal entity's attributes of the sellers, including at least one of the sellers' names, surnames, identification numbers, images, pictures, brands, trade marks, logotypes, intellectual properties, properties, rights, place, space, popularity, reputation, trust, prestige, money, currency, phone numbers, mobile phone numbers, spaces of time, duration of time, sound, words, phrases, songs, languages, energy, light, water, foods, smells, taste, air or gas quotes of emission and other person's or legal entity's attributes of sellers, and
the variable part contains person's or legal entity's attributes of the purchasers, including at least one of the purchasers' names, surnames, identification numbers, images, pictures, brands, trade marks, logotypes, intellectual properties, properties, rights, place, space, popularity, reputation, trust, prestige, money, currency, phone numbers, mobile phone numbers, spaces of time, duration of time, words, phrases, songs, sound, energy, light, water, food, smells, taste, air or gas quotes of emission and other person's or legal entity's attributes of purchasers.
